(19) United States
(12) Patent Application Publication
(10) Pub. No.: US 2016/0138383 A1
(43) Pub. Date: May 19, 2016

(54) Method For Forming Lanthanide Scintillators

(71) Applicant: SCHLUMBERGER TECHNOLOGY CORPORATION, Sugar Land, TX (US)

(72) Inventor: Irina MOLODETSKY, Princeton Junction, TX (US)

(21) Appl. No.: 14/899,291

(22) PCT Filed: Jun. 24, 2014
(86) PCT No.: PCT/US2014/043921

§ 371 Date: Dec. 17, 2015

Related U.S. Application Data
(60) Provisional application No. 61/838,688, filed on Jun. 24, 2013.

(51) Int. Cl. E21B 47/00; C01F 17/00

(52) U.S. Cl. CPC E21B 47/00; C01F 17/0018

(57) ABSTRACT

A method of forming a scintillator includes processing soluble precursor ceramic lanthanide materials to form a calcined powder. This powder is spark plasma sintered to density the calinced powder into a lanthanide scintillator.

### RELATED APPLICATION(S)

This application is based upon prior filed provisional application Ser. No. 61/838,688 filed on Jun. 24, 2013, the entire contents of which are incorporated herein by reference.

### BACKGROUND

Radiation detectors, such as gamma-ray detectors may include a scintillator material that converts a given type of radiation, e.g., gamma-ray, into light. The light is directed to a photodetector, which converts the light generated by the scintillator into an electrical signal, which may be used to measure the amount of radiation that is incident on the crystal. In the case of well-logging tools for hydrocarbon wells, e.g., gas and oil wells, a borehole gamma-ray detector may be incorporated into the tool string to measure radiation from the geological formation surrounding the borehole to determine information about the geological formation, including the location of gas and oil pockets.

Lanthanide based crystals are useful in scintillators to detect gamma rays and x-rays in borehole logging applications, where gamma ray measurements are used to determine properties of the subterranean formations. Numerous crystal compositions are known including lutetium aluminum perovskite crystals. These materials may be grown from a melt, for example, using crystal growth methodologies or a sintering process using powder metallurgy techniques. The desired perovskite phase, however, tends to be unstable, especially for the higher atomic number lanthanides, such as lutetium, and can disproportionate to a garnet phase and a lanthanide oxide phase, for example, by changing from one oxidation state into two different phases or oxidation states in an aqueous solution. This technical problem may occur, for example, when fabricating lanthanide based perovskite crystal scintillators.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

An example method of forming a scintillator includes processing soluble precursor ceramic lanthanide materials to form a calcined powder. This powder is spark plasma sintered to density the calinced powder into a lanthanide scintillator.

In another example, a method of forming a lanthanide scintillator includes dissolving precursor ceramic lanthanide materials in a liquid solvent to form a solution. The solution is processed to form a powder or gel derived from the precursor ceramic lanthanide materials. The powder or gel is calcined to form a calcined powder, which is spark plasma sintered to densify the calcined powder into a lanthanide scintillator having a perovskite or garnet crystal structure.

In another example, a method of forming a scintillator detector for a well-logging tool includes processing soluble precursor ceramic lanthanide materials to form a calcined powder and spark plasma sintering the calcined powder to densify the calcined powder into a lanthanide scintillator. This lanthanide scintillator is ground and polished into a final scintillator detector shape.

### BRIEF DESCRIPTION OF THE DRAWINGS

FIG. 1 illustrates an example method for forming a lanthanide scintillator in accordance with one or more embodiments.

FIG. 2 illustrates a hydraulic press for spark plasma sintering to form the lanthanide scintillator in accordance with one or more embodiments.

FIG. 3 illustrates a radiation detector that incorporates the lanthanide scintillator in accordance with one or more embodiments.

FIG. 4 illustrates another example radiation detector that incorporates the lanthanide scintillator in accordance with one or more embodiments.

FIG. 5 illustrates a well-logging tool in which the radiation detector of FIGS. 3 and 4 may be incorporated in accordance with one or more embodiments.

### DETAILED DESCRIPTION

The present description is made with reference to the accompanying drawings, in which example embodiments are shown. However, many different embodiments may be used, and thus the description should not be construed as limited to the embodiments set forth herein. Rather, these embodiments are provided so that this disclosure will be thorough and complete. Like numbers refer to like elements throughout, and prime and multiple prime notation are used to indicate similar elements in different embodiments.

A process for fabricating a lanthanide scintillator, for example, perovskite or garnet phase scintillator, includes an initial wet chemistry synthesis where precursor ceramic materials are dissolved in a solvent, e.g., an aqueous solvent. The wet chemistry synthesis is followed by a gelation or precipitation process to obtain either a respective gel or a powder. The gel or powder may be further processed, for example, by drying, cleaning, or grinding prior to calcination, in which any residual solvent is volatilized. The calcined powder may then be moved into a die for spark plasma sintering where the powder is densified into a solid ceramic material. This process enables fabrication of lanthanide scintillators having perovskite or garnet crystal phases and may be stabilized against disproportionation to other thermodynamically favored phases.

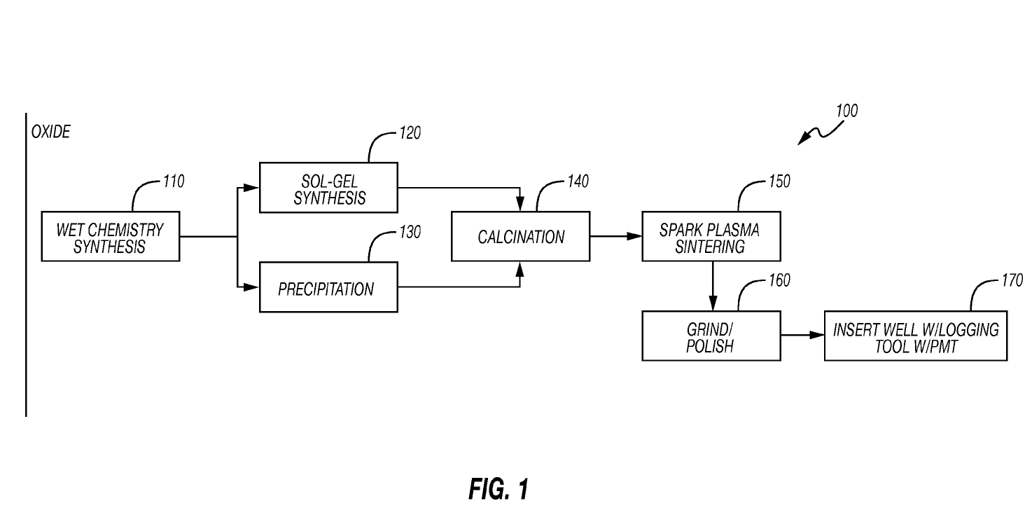

FIG. 1 is a flow diagram of an example method 100 for fabricating a lanthanide scintillator, for example, a lanthanide based perovskite or garnet crystal scintillator. The method 100 includes wet chemistry synthesis 110 in which the precursor ceramic material components, for example, the lanthanide and other precursor materials are dissolved in either an aqueous, organic, or mixed solvent to form an aqueous solution. Wet chemistry synthesis 110 is followed by either a sol-gel 120 or precipitation 130 process in which either a gel (derived from the sol-gel synthesis) or a powder (derived from precipitation) is obtained. The gel or powder may be further processed, for example, by drying, cleaning, or grinding prior to calcination at 140, in which the residual solvent, for example, alcohols and water, is volatilized. The calcined powder is moved into a die for spark plasma sintering 150 in which the powder is densified into a solid ceramic material.

The lanthanide scintillator formed from the spark plasma sintering 150 is then ground and polished 160 into a final scintillator shape or configuration such as a final cuboid or cylindrical shape as a final scintillator detector shape. It is connected to a photomultiplier tube to form a radiation detector and inserted within a well-logging tool 170.

Wet chemistry synthesis 110 is used to obtain a liquid solution, in which the soluble precursor materials, e.g., lutetium and aluminium when fabricating a lutetium aluminium scintillator, are homogeneously mixed at the molecular level. The precursor materials are added to the solution with a predetermined molar ratio equivalent to the molar ratio in the desired ceramic phase. For example, lutetium and aluminium containing compounds may be added to the solution in a one to one molar ratio when the desired ceramic phase is a perovskite. In another example, lutetium and aluminium compounds may be added to the solution in a three to five molar ratio when the desired ceramic phase is a garnet.

The precursor materials may include, for example, compounds that disassociate in a solvent to form one of at least aluminium and silicon containing cations in solution. These compounds may include a suitable aluminium or silicon containing compound containing one or both components, such as aluminium isopropoxide, Al(OC₃H₇)₃, aluminium butooxide, Al(OC₄H₉)₃, and tetraethyl orthosilicate, Si(OC₂H₅)₄. The precursor materials may further include, for example, compounds that disassociate in a solvent to form germanium, lutetium, yttrium, and gadolinium containing anions. Such suitable compounds may include at least one of germanium, lutetium, yttrium, and gadolinium containing compounds, such as tetraethyl orthogermanite, Ge(OC₂H₅)₄, lutetium acetate hydrate, Lu(OC₂H₃)₃, yttrium isopropoxide, Y(OC₂H₅)₃, and gadolinium isopropoxide, Gd(OC₃H₇)₄.

The wet chemistry synthesis 110 is followed by the sol-gel synthesis 120 or precipitation 130 or a combination of both and is performed at low temperatures and pressures, for example, at temperatures less than 100 degrees C. and at pressures about equal to atmospheric pressure, such that a substantially amorphous (or glassy) gel or powder is obtained. Gelation through the sol-gel synthesis 120 or precipitation 130 through a precipitation process or a combination of both processes together may be initiated by techniques known to those skilled in the art, for example, by increasing the pH of the solution, adding water or a mixed solvent to the liquid solution, or reducing the temperature of the liquid solution. The disclosed embodiments are not limited to any particular techniques for initiating gelation or precipitation of a sol.

In an example embodiment, wet chemistry synthesis refers to chemical synthesis accomplished in the liquid phase. It is termed bench chemistry synthesis by some skilled in the art because many of the tests are performed on a small scale at a laboratory bench. Wet chemistry production processes are now automated and computerized for streamlined analysis and synthesis. Sol-gel processing as known to those skilled in the art produces solid materials from small molecules. The “sol” as a colloidal suspension in a solution evolves towards the formation of a gel-like diphasic system and contains in an example a liquid phase and a solid phase in a non-limiting example.

Those of ordinary skill in the art will understand that the term ‘sol’ refers to a colloidal suspension of solid macromolecular particles in a liquid. The solid precipitated particles have a diameter generally in the range from about 1 (one) to about 1,000 nm and are free to move in the liquid, i.e., the particles tend not to be rigidly bound to each other.

Those of ordinary skill in the art will understand that the term ‘gel’ in the sol-gel synthesis 120 refers to a colloidal suspension in which the dispersed material (e.g., particles) form a continuous (or semi-continuous) cross-linked system in the liquid. The dispersed material tends not to move about in the liquid as the particles are cross-linked to each other. With respect to FIG. 1, the gelation at 120 referring to sol-gel synthesis forms a gel, for example, via polycondensation. With respect to the process shown in FIG. 1, the precipitation at 130 is intended to promote hydrolysis and form a sol.

In an example, predetermined molar quantities of lutetium nitrate and aluminium nitrate may be dissolved in an aqueous solution to form a dissolved mixture of lutetium and aluminium ions. Ammonium nitrate may then be added to the mixture to increase the pH. As the pH increases with the addition of the ammonium nitrate, the aqueous solution becomes thermodynamically unstable and a lutetium aluminium oxide gel is formed. The gel may then be filtered out of the remaining solution and repeatedly washed and dried to remove residual ammonium nitrate. The gel is dried, and after drying, may optionally be ground to form a substantially amorphous or glassy powder.

In another example, predetermined molar quantities of lutetium acetate hydrate, Lu(OC₂H₃)₃, and aluminium butoxide, Al(OC₄H₉)₃, may be dissolved in an aqueous solution to form the dissolved mixture of lutetium and aluminium ions. Ammonium nitrate may then be added to the mixture to increase the pH. As the pH increases (with the addition of the ammonium nitrate) the aqueous solution becomes thermodynamically unstable and a lutetium aluminium oxide gel is formed as in the previous example. The gel may then be filtered out of the remaining solution and repeatedly washed and dried to remove residual ammonium nitrate. The gel is dried, and after drying, the gel may optionally be ground to form a substantially amorphous or glassy powder. In another embodiment, the powder may precipitate directly out of the solution. The disclosed embodiments are not limited to these examples.

Lanthanide scintillators sometimes include one or more rare earth doping elements to enhance certain properties of the scintillator as known to those skilled in the art. Rare earth dopants for use with scintillators may include, for example, other lanthanides, including at least one of cerium, praseodymium, neodymium, samarium, and europium. These dopants may be added to the sol by adding an alkoxide at least one of cerium and praseodymium alkoxide, to the mixture formed during the wet chemistry synthesis at 110.

The powder obtained from the sol-gel synthesis 120 or precipitation 130 is calcined at 140 to remove adsorbed and chemically bound water. The calcination process may involve heating the powder to a high enough temperature to drive off the adsorbed and chemically bound water, but maintain a low enough temperature that will not promote grain growth in the powders. Suitable calcination temperatures may be in the range, for example, from about 400 to about 500 degrees C., although the disclosed embodiments are by no means limited to this temperature range. As understood by those skilled in the art, calcination as a thermal treatment process may occur in the presence of air or oxygen to bring about a thermal decomposition, phase transition, or removal of a volatile fraction. The calcination reaction may occur at or above a thermal decomposition temperature for a decomposition and volatilization reaction or the transition temperature for a phase transition. This temperature in some embodiments may be the temperature at which the standard Gibbs free energy for the calcinations reaction is equal to zero. There may be some oxidation. In a sol-gel processing the polymer network containing metal compounds may be heated to convert them into an oxide network.

The calcined powders are moved to a die for spark plasma sintering 150 to form a densified ceramic. Spark plasma sintering is distinct from conventional high temperature sintering processes because in spark plasma sintering, a pulsed electrical current is passed through both the die and the powder sample simultaneously while compacting the sample under pressure. The electrical current heats the powder internally and therefore facilitates very high heating and cooling rates, e.g., up to 1,000 degrees C. per minute in an example. Such rapid heating and cooling promotes rapid densification of the powders while maintaining the amorphous like or nano-scale grain structure in the original powders. Spark plasma sintering (SPS) may include a pulsed DC current that passes through a graphite die powder compact and densifies the powders having a nanosize or nanostructure, but avoids coarsening.

In an example, a micro-spark is discharged in the gap between neighboring powder particles. Plasma heating occurs where the electrical discharge between powder particles results in localized heating of particle surfaces. Because the micro-plasma discharges uniformly through a sample, the generated heat is uniformly distributed. Particle surfaces are activated and purified and impurities concentrated on the particle surface are vaporized. The purified surface layers of the particles melt and fuse to each other. The pulsed DC electrical current flows from particle to particle and the joule heat increases diffusion, enhancing growth. The heated material becomes softer and exerts a plastic deformation under a uniaxial force in an example. Spark plasma sintering in an example is performed in a graphite die with uniaxial (die) pressing with an example load above 15,000 psi/100 mpa. This force is transferred through an upper punch to the powder. A pulsed DC power supply is connected to upper and lower punches that form the electrodes. In an example, the voltage may be a few volts, but the current is several thousand amperes. The DC pulse time may be a few to tens of milliseconds and a DC pulse time may be a few to tens of milliseconds. These are non-limiting examples. Some spark plasma sintering may occur in a 5-20 minute time frame as an example, but may be a longer timeframe as explained below. Spark plasma sintering may obtain a metastable state and grain boundaries that are stabilized by surface energy.

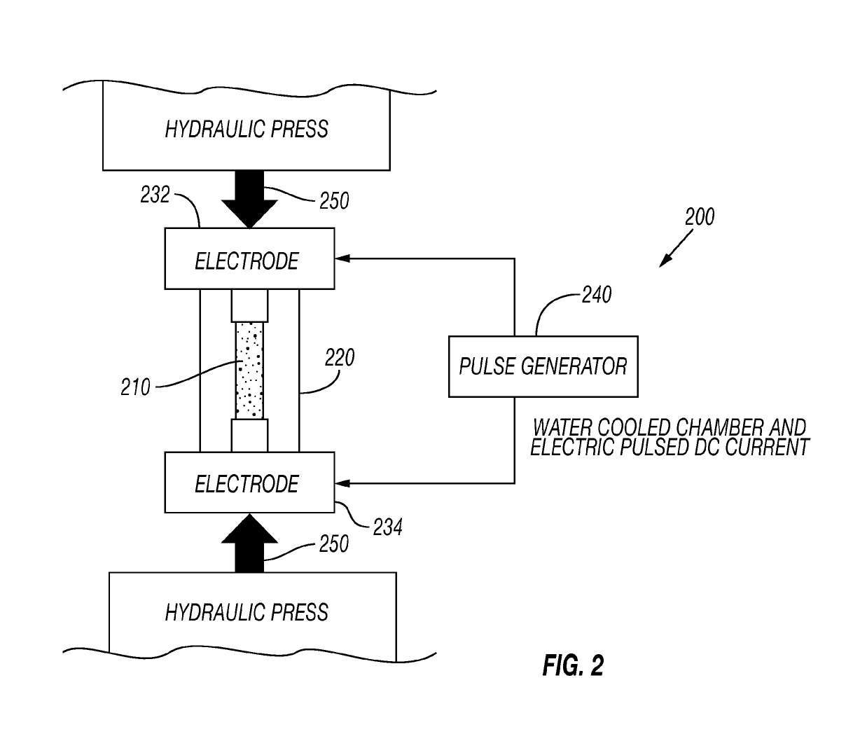

FIG. 2 schematically shows an embodiment of a spark plasma sintering device 200. In this illustrated embodiment, the calcined powder 210 is poured into the die 220. Upper and lower electrodes 232 and 234 are formed, for example, as electrically conductive graphite electrodes and are positioned on either end of the die 220 about the powder sample 210. The electrodes are connected to a high power pulse generator 240, which provides the pulsed electrical current that passes through the powder sample 210. The pulse generator 240 may provide a pulsed direct electrical current (DC) of up to or greater than 2,000 or more amperes. The die 220 and electrodes 232 and 234 may be positioned in the hydraulic press, which is illustrated schematically at 250. The powders may be compacted and densified. The hydraulic press 250 may provide large compressive loads to the sample 210, for example, from about 30 to about 300 ksi. The die may be further positioned in a water cooled vacuum chamber (not shown) to promote rapid cooling of the sample upon the completion of the process.

The method 100 as described relative to FIG. 1 may be used to fabricate suitable lanthanide based scintillators. Those skilled in the art will understand that the term lanthanide refers to the fifteen metallic chemical elements having atomic numbers 57 through 71 (from lanthanum through lutetium). The scintillators may be substantially any suitable phase, for example, including the perovskite and garnet phases.

As is known to those skilled in the art, the perovskite structure may be represented as being ABO₃ in which A and B represent distinct metallic cations having different ionic radii and are bonded to each other by their oxygen atoms. In the disclosed lanthanide based perovskite scintillator embodiments, A may represent a lanthanide, for example, including lanthanum, gadolinium, or lutetium. A may also represent a mixture of one or more lanthanide series elements, e.g., including a lanthanum lutetium mixture. B may represent a metallic element, for example, including a trivalent metallic element such as aluminium, scandium, or gallium. B may also represent a mixture of one or more metallic elements or trivalent metallic elements, for example, including a mixture of aluminium and gallium in substantially any suitable proportion. Example lanthanide perovskite compositions that may be fabricated by the method described in FIG. 1 are given in Table 1.

TABLE 1
Lanthanide Perovskite Compositions

| | | | | |
|---|---|---|---|---|
| A1 | A2 | B1 | B2 | O |

| | | | |
|---|---|---|---|
| Lu | Al | | 3 |
| Lu | Sc | | 3 |
| La | Al(x) | Ga(1 − x) | 3 |
| Gd | Al(x) | Ga(1 − x) | 3 |
| Lu | Al(x) | Ga(1 − x) | 3 |

The garnet structure may be represented as being A₃B₅O₁₂ where A and B represent distinct cations having different ionic radii and are bonded to each other via the oxygen atoms. In garnet crystals, A may be a divalent cation while B may be a trivalent cation. In an example lanthanide based garnet scintillator embodiment, A represents a lanthanide, for example, including lanthanum, gadolinium, or lutetium. A may also represent a mixture of one or more lanthanide series elements, e.g., including lanthanum lutetium mixture. B may represent a trivalent metallic element such as aluminium, scandium, or gallium. B may also represent a mixture of one or more trivalent metallic elements, for example, including a mixture of aluminium, scandium, and gallium in suitable proportions. Example lanthanide garnet compositions that may be fabricated by the method 100 described in FIG. 1 are given in Table 2.

TABLE 2
Lanthanide Garnet Compositions

| A1 | A2 | B1 | B2 | O |
|---|---|---|---|---|
| Gd (3) | NA | Sc(2 − x)Y(x) | Al(3 − y)Ga(y) | 12 |
| Gd (3) | NA | Sc(2 − x)Y(x) | Al(y)Ga(3 − y) | 12 |
| Lu(3) | NA | Sc(2 − x)Y(x) | Al(3 − y)Ga(y) | 12 |
| La(3) | NA | Ga(3) | Lu(2) | 12 |
| Lu(3) | NA | Ga(5) | | 12 |
| Gd(3) | NA | | Al(y)Ga(5 − y) | 12 |
| Gd(3 − z) | Lu(z) | | Al(y)Ga(5 − y) | 12 |

The powder samples may be densified under suitable processing conditions, for example, depending on the thermal and mechanical properties of the powder. Various parameters that are controlled during the processing may include the temperature, the applied pressure, the current density, and the time. The temperature may be in a range, for example, from about 600 to about 2,000 degrees C. The applied pressure may be in a range, for example, from about 30 to about 300 ksi (30,000 to 300,000 psi). The current density may be in a range, for example, from about 100 to 1,000 A/cm². The processing time may be in a range, for example, from about 10 to about 200 minutes.

The use of spark plasma sintering enables the scintillators to be fabricated near to the final scintillator shape, e.g., in a final cuboid or cylindrical shape. Notwithstanding the above, the method 100 described relative to the sequence shown in FIG. 1 may further include subsequent grinding and polishing to obtain the final scintillator configuration.

The fabricated scintillator embodiments may involve use of different analytical techniques during fabrication. For example, electron microscopy techniques may be used to evaluate the grain size of the fabricated samples. X-ray powder diffraction may be used to evaluate the phase composition. Inductively coupled plasma optical emission spectroscopy (ICP-OES) may be used to assess the chemical composition. The actual density as compared to the theoretical density may also be evaluated. Moreover, an emission spectra may be obtained for the different scintillator embodiments.

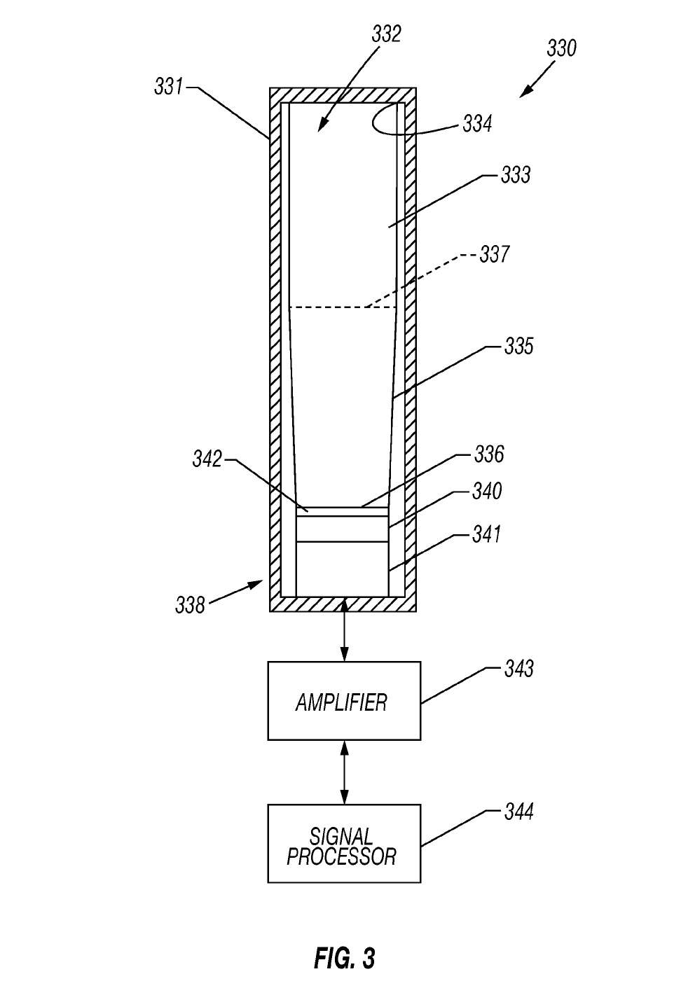

Referring now to FIG. 3, an embodiment of a radiation detector 330 that incorporates the lanthanide scintillator is described. The radiation detector 330 includes a detector housing 331, which in the illustrated example is cylindrical, such as for use in a well-logging tool, as will be described further below. The detector housing 331 may be formed from a metal such as aluminum or similar materials, which allows gamma rays to pass through. A scintillator body 332 formed for example as the fabricated lanthanide scintillator is carried within the detector housing 331 and includes a proximal portion 333 defining a proximal end 334, a distal portion 335 defining a distal end 336, and a medial portion 337 between the proximal portion and the distal portion. The radiation detector 330 further includes a photodetector 338 coupled to the distal end 336 of the scintillator body 332 and carried within the detector housing. In the illustrated example, the photodetector 338 includes a photomultiplier window 340 coupled to the distal end 336 of the scintillator body via an optional optical coupler 342, for example, a silicon pad or similar component, and a photocathode 341 on the interior surface of the photomultiplier window. However, other suitable photodetector configurations may be used in different embodiments, such as an avalanche photodiode (APD) configuration, for example.

In the case of gamma-rays, when charged particles pass through the detector housing 331 and strike the scintillator body 332, energy deposited by the gamma-rays is converted into light and received by the photodetector 338. The photodetector 338 converts the light from the scintillator body 332 into an electrical signal. The electrical signal may be amplified by an amplifier(s) 343, which may provide an amplified signal to a signal processor or processing circuitry 344. The signal processor 344 may include a general or special-purpose processor, such as a microprocessor or field programmable gate array, and associated memory, and may perform a spectroscopic analysis of the electrical signal, for example. A reflector material (not shown) may surround the scintillator body 332 to help prevent light from escaping except via the photomultiplier window 340. It should be noted that while the embodiments herein are described with reference to gamma-ray detection, the various configurations and method aspects discussed herein may also be used for other types of radiation detectors as well.

By way of background, with respect to gamma-ray detectors, it may be desirable that gamma-rays of equal energy that interact in different parts of the scintillator body 332 transfer the same amount of light to the photodetector 338. Low light levels and non-uniform light collection from different parts of the scintillator body 332 may both reduce the gamma-ray energy resolution of the photodetector 338. In the case of oilfield logging tools, an external pressure housing may be used, for example, a sonde housing with a high strength steel, to isolate the instrumentation from the high pressure environment of the borehole. The diameter of a gamma-ray scintillator is accordingly constrained by the internal diameter of the sonde housing.

The size of the photocathode 341 will also be similarly constrained within a well logging tool, and may have a diameter that is smaller than that of the detector, or in the case of a packaged (hygroscopic) scintillator, an exit window in a scintillator housing. In the case of a hygroscopic scintillator, the scintillator housing may be contained inside the detector housing to provide additional protection for the scintillator body from the ambient atmosphere, and in particular from moisture. Generally speaking, light coupling from a cylindrical end of a scintillator to a photomultiplier cathode or an exit window of the scintillator housing, which are both of a smaller diameter, may be relatively poor. This is because some light exits the scintillator through the end area that is not covered by the photocathode. In this embodiment, the scintillator body 332 has a constant diameter along the proximal portion 333, and a decreasing diameter along the distal portion 335 from the medial portion 337 to the distal end 336. The distal portion 335 of the scintillator body 332 has a cone-shaped taper which terminates or truncates in a flat bottom (i.e., the distal end 336), which provides improved optical coupling between the scintillator body 332 and the photodetector 338.

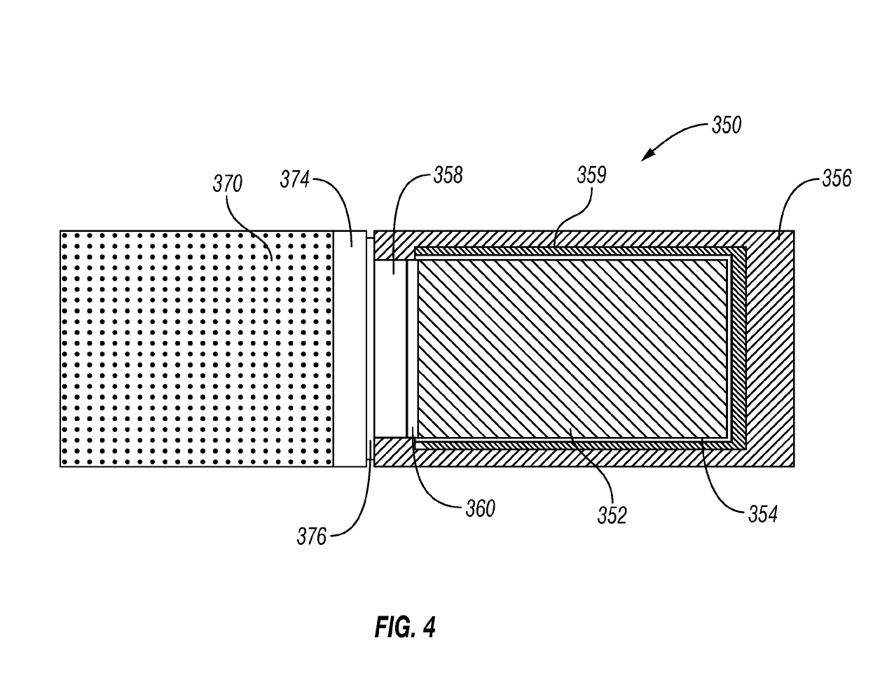

FIG. 4 is another embodiment of the detector that may incorporate the lanthanide scintillator as described. A scintillator crystal package 350 is assembled from individual parts. A scintillator crystal 352 is surrounded by one or more layers of a diffuse reflector 354. The wrapped crystal 352 may be inserted in a hermetically sealed housing 356, which may have an optical window 358 already attached or added later. The window 358 may be sapphire or glass as known to those skilled in the art. The housing 356 may be filled with a shock absorber 359 material, e.g., a silicon (RTV) that fills the space between the scintillator crystal 352 and the inside diameter of the housing 356. Optical contact between the scintillator crystal 352 and the window 358 of the housing 356 is established using an internal optical coupling pad 360 formed in one example as a transparent silicon rubber disk.

The scintillator may be used at high temperatures and in an environment with large mechanical stresses. The scintillator is combined with a suitable photodetection device to form a radiation detector. The photodetection devices can be photomultipliers (PMTS), position sensitive photomultipliers, photodiodes, avalanche photodiodes (APDs), photomultipliers based on microchannel plates (MCPs) for multiplication and a photocathode for the conversion of the photon pulse into an electron pulse. APDs are known to be useful in high temperature environments and may be formed from silicon containing materials.

Given their properties, these detectors are particularly suited for use in downhole applications for the detection of gamma rays in many of the instruments known in the art. The tools in which the detectors are used can be converted by any means of conveyance in the borehole, including without limitation, tools conveyed o wireline, drill strings, coiled tubing, or any other downhole conveyance apparatus. The detector may include an avalanche photodiode (APD), which may be a high-speed, high sensitivity photodiode utilizing an internal gain mechanism that functions by applying a reverse voltage. APDs are useful in high temperature environments and may be formed from silicon containing materials.

A photomultiplier (PMT) 370 is operable with a scintillation crystal 352 as illustrated. The scintillation detector 350 is coupled to the entrance window 374 of the PMT 370 by an optical coupling layer 376 to optimize the transmission of the light from the scintillator 352 (through the optical coupling 360 and the scintillator window 358) to the PMT 370. It is also possible to mount a scintillator directly to the PMT with a single optical coupling and combine the PMT and scintillator into a single hermetically sealed housing. The scintillator crystal 352 may receive gamma rays from hydrocarbons in formations. This energy may cause electrons in one or more activator ions in the scintillation material to rise to higher energy levels. The electrons may then return to the lower or “ground” state, causing an emission of photon in the ultraviolet. The photon is then converted in an electron in the photocathode of the PMT and the PMT amplifies the resulting electron signal.

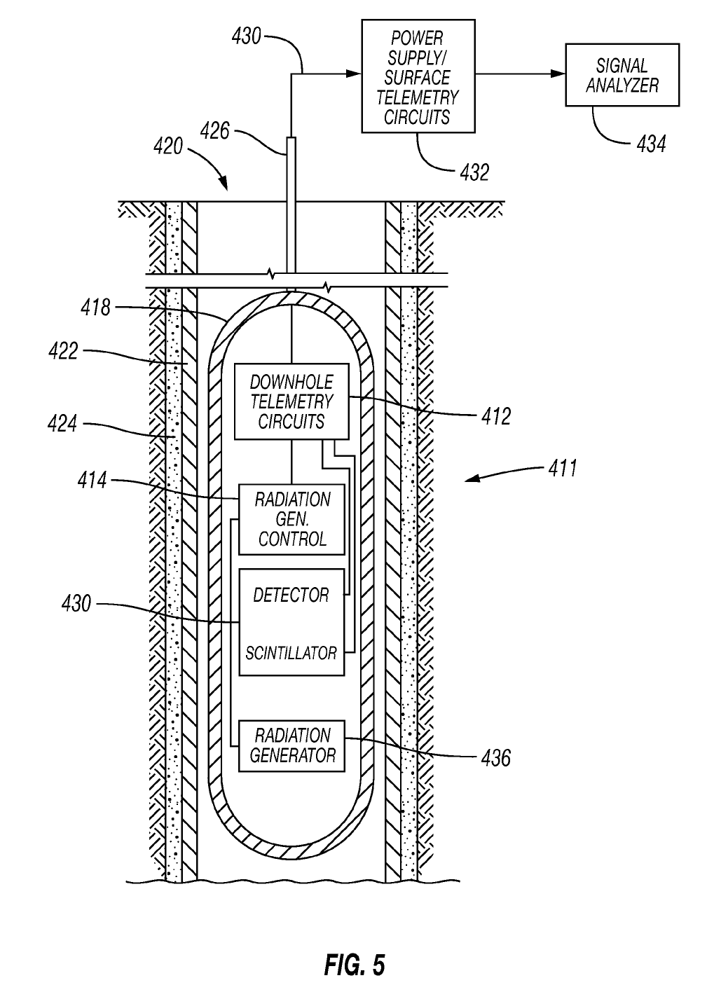

An example embodiment of a well-logging tool is shown in FIG. 5 in which one or more detectors 330 or 350 (similar to those described above) may be used. The detectors 330 or 350 are positioned within a sonde housing 418 along with a radiation generator 436 (e.g., Gamma-ray generator, etc.) and associated high voltage electrical components (e.g., power supply). Supporting control circuitry 414 for the radiation generator 436 (e.g., low voltage control components) and other components, such as downhole telemetry circuitry 412, may also be carried in the sonde housing 418.

In operation, the sonde housing 418 is moved through a borehole 420. In the illustrated example, the borehole 420 is lined with a steel casing 422 and a surrounding cement annulus 424, although the sonde housing and radiation generator 436 may be used with other borehole configurations (e.g., open holes). By way of example, the sonde housing 418 may be suspended in the borehole 420 by a cable 426, although a coiled tubing, etc., may also be used. Furthermore, other modes of conveyance of the sonde housing 418 within the borehole 420 may be used, such as wireline, slickline, Tough Logging Conditions (TLC) systems, and logging while drilling (LWD), for example. The sonde housing 418 may also be deployed for extended or permanent monitoring in some applications.

A multi-conductor power supply cable 430 may be carried by the cable 426 to provide electrical power from the surface (from power supply circuitry 432) downhole to the sonde housing 418 and the electrical components therein (i.e., the downhole telemetry circuitry 412, low-voltage radiation generator support circuitry 414, and one or more of the above-described radiation detectors 330). However, in other configurations, power may be supplied by batteries and/or a downhole power generator, for example.

The radiation generator 436 is operated to emit neutrons to irradiate the geological formation adjacent the sonde housing 418. Photons (i.e., gamma-rays) that return from the formation are detected by the radiation detectors 330. The outputs of the radiation detectors 330 may be communicated to the surface via the downhole telemetry circuitry 412 and the surface telemetry circuitry 432, which may be analyzed by a signal analyzer 434 to obtain information regarding the geological formation. By way of example, the signal analyzer 434 may be implemented by a computer system executing signal analysis software for obtaining information regarding the formation. Oil, gas, water and other elements of the geological formation have distinctive radiation signatures that permit identification of these elements. Signal analysis can also be carried out downhole within the sonde housing 418 in some embodiments.

Many modifications and other embodiments will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

That which is claimed is:

1. A method of forming a scintillator, comprising:
processing soluble precursor ceramic lanthanide materials to form a calcined powder; and
spark plasma sintering the calcined powder to densify the calcined powder into a lanthanide scintillator.

2. The method according to claim 1, comprising spark plasma sintering the calcined powder to have a perovskite crystal structure for the lanthanide scintillator.

3. The method according to claim 2, comprising forming the perovskite crystal structure as ABO₃ in which A represents at least one lanthanide and B represents at least one trivalent metallic element and A and B are bonded to each other via their oxygen atoms.

4. The method according to claim 1, comprising spark plasma sintering the calcined powder to have a garnet crystal structure for the lanthanide scintillator.

5. The method according to claim 4, comprising forming the garnet crystal structure as A₃B₅O₁₂ in which A represents at least one lanthanide and B represents at least one trivalent metallic element and A and B are bonded to each other via their oxygen atoms.

6. The method according to claim 1, comprising spark plasma sintering the calcined powder at a temperature from about 600 to about 2,000 degrees centigrade and at pressure from about 30,000 psi to about 300,000 psi for about 10 minutes to about 200 minutes.

7. The method according to claim 6, comprising applying a current density from about 100 to about 1,000 A/cm2.

8. The method according to claim 1, comprising,
dissolving the precursor ceramic lanthanide materials in a liquid solvent to form a solution;
precipitating or sol-gel synthesizing the solution to form a respective powder or gel; and
calcining the powder or gel to form the calcined powder.

9. The method according to claim 1, comprising adding a rare earth dopant to the solution.

10. A method of forming a lanthanide scintillator, comprising:
dissolving precursor ceramic lanthanide materials in a liquid solvent to form a solution;
processing the solution to form a powder or gel derived from the precursor ceramic lanthanide materials;
calcining the powder or gel to form a calcined powder; and
spark plasma sintering the calcined powder to densify the calcined powder into a lanthanide scintillator having a perovskite or garnet crystal structure.

11. The method according to claim 10, comprising adding lutetium and aluminum containing compounds to the solution in a one to one molar ratio to form a perovskite crystal structure.

12. The method according to claim 10, comprising adding lutetium and aluminum containing compounds to the solution in a three to five molar ratio to form a garnet crystal structure.

13. The method according to claim 10, wherein the processing the solution to form a powder or gel comprises precipitating or sol-gel synthesizing the solution.

14. The method according to claim 13, comprising volatilizing any residual solvent within the powder or gel prior to calcining.

15. The method according to claim 10, comprising spark plasma sintering the calcined powder at a temperature from about 600 to about 2,000 degrees centigrade and at pressure from about 30,000 psi to about 300,000 psi for about 10 minutes to about 200 minutes.

16. The method according to claim 15, comprising applying a current density from about 100 to about 1,000 A/cm2.

17. The method according to claim 10, comprising adding a rare earth dopant to the solution.

18. A method of forming a scintillator detector for a well-logging tool, comprising:
processing soluble precursor ceramic lanthanide materials to form a calcined powder;
spark plasma sintering the calcined powder to densify the calcined powder into a lanthanide scintillator; and
grinding and polishing the lanthanide scintillator into a final lanthanide scintillator detector.

19. The method according to claim 18, comprising connecting the lanthanide detector to a photomultiplier tube to form a radiation detector.

20. The method according to claim 19, comprising incorporating the radiation detector within a well-logging tool.
